(19) United States
(12) Patent Application Publication
(10) Pub. No.: US 2021/0037631 A1
(43) Pub. Date: Feb. 4, 2021

(54) SYSTEM AND METHOD FOR DYNAMIC LIGHTING USING A NARROWBAND WIRELESS LIGHTING NETWORK

(71) Applicant: SIGNIFY HOLDING B.V., Eindhoven (NL)

(72) Inventors: Jin YU, Lexington, MA (US); John WARWICK, Shutesbury, MA (US); Talmai BRANDÃO DE OLIVEIRA, North Andoover, MA (US)

(73) Assignee: Signify Holding B.V., Eindhoven (NE)

(21) Appl. No.: 16/647,714

(22) PCT Filed: Sep. 5, 2018
(86) PCT No.: PCT/EP2018/073866

§ 371 Date: Mar. 16, 2020

Related U.S. Application Data
(60) Provisional application No. 62/559,162, filed on Sep. 15, 2017.

(30) Foreign Application Priority Data
Oct. 3, 2017 (EP) 17194543.9

(51) Int. Cl. H05B 47/155; H05B 47/19; H04L 12/28

(52) U.S. Cl. CPC H05B 47/155; H05B 47/19; H04L 12/283; H04L 2012/285; H04L 12/2814; H04L 2012/2841; H04L 12/282

(57) ABSTRACT

A system (100) for dynamic lighting including: a plurality of lighting units (10) each having a light source (12), a unique identifier, and a communications module (24a); and a gateway (20) having a communications module (24b) configured to communicate via a low-bandwidth wireless communication method with the lighting units, and having a controller (26) configured to: (i) receive instructions for a dynamic lighting pattern for a first time period for the plurality of lighting units; (ii) generate sequential command files each comprising information for a sequential subset of the first time period, each of the plurality of sequential command files further comprising instructions for timing and color for each of the plurality of lighting units and associated with an identifier for a respective lighting unit; (iii) compress each of the plurality of sequential command files; and (iv) sequentially transmit the plurality of sequential command files to the lighting units.

### FIELD OF THE INVENTION

The present disclosure is directed generally to methods and lighting systems configured for fast dynamic lighting within a narrowband, low bandwidth, wireless lighting network.

### BACKGROUND

Dynamic lighting is an increasingly important aspect of lighting systems and design. There is a need for lighting systems and configurations that are capable of displaying complex lighting patterns or shows with rapid color and/or intensity changes. For wired lighting networks, transmitting the information necessary to drive a dynamic lighting pattern is facilitated by the adequate bandwidth of these systems.

In contrast, the low data rate or low throughput of low bandwidth wireless communication networks such as ZigBee® and Bluetooth® makes it difficult or impossible to implement dynamic lighting with a fast frame rate. Many wired systems have a sufficiently high data rate, such as 250 Kbps with 40 frames per second, while a wireless system such as ZigBee might have an achievable data rate of only 50-75 Kbps. More importantly, the system capacity might be limited by the number of packets which can go through the network. However, since ZigBee and Bluetooth systems such as Bluetooth Low Energy (BLE) have been widely accepted in lighting industries for lighting units, there is increasingly more demand for support of dynamic lighting.

Dynamic lighting also requires a high level of synchronization, but the latency through a wireless network such as a mesh network with multiple hops does not allow for a true transition to occur, and the final outcome is easily observed by human eyes as having variable delays between the nodes which might be regarded as a failure for the lighting show.

Accordingly, there is a continued need in the art for lighting systems capable of fast dynamic lighting using a low bandwidth wireless communication network.

### SUMMARY OF THE INVENTION

The present disclosure is directed to inventive methods and systems for communicating instructions for dynamic lighting. Various embodiments and implementations herein are directed to a system configured to a lighting network configured for dynamic lighting using narrow bandwidth wireless communication. The system includes a plurality of lighting units, each with a unique identifier, in wireless communication with a gateway via a low bandwidth communication method. The system receives instructions for a dynamic lighting pattern, and generates sequential command files for a subset of the lighting pattern time period, each of the command files including instructions for timing and a color or color pattern for each of the plurality of lighting units. A single sequential command file contains instructions for all of the lighting units, and instructions for each lighting unit are associated with the unique identifier for that lighting unit. The lighting unit receives the compressed instructions, decompresses them, and adds them to a buffer to be executed. Subsequent command files are then sent by the system and received by the lighting units for execution.

Generally, in one aspect, a system for dynamic lighting is provided. The system includes: a plurality of lighting units each having at least one light source, a unique identifier, and a communications module; and a gateway comprising a communications module configured to communicate via a low-bandwidth wireless communication method with the communications module of the lighting units, and comprising a controller configured to: (i) receive instructions for a dynamic lighting pattern for a first time period for the plurality of lighting units; (ii) generate a plurality of sequential command files each comprising information for a sequential subset of the first time period, each of the plurality of sequential command files further comprising instructions for timing and color for each of the plurality of lighting units, each of said instructions associated with an identifier for a respective lighting unit; (iii) compress each of the plurality of sequential command files; and (iv) transmit a first one of the plurality of sequential command files to the plurality of lighting units; where each of the plurality of lighting units are configured to receive and decompress the first sequential command file, and further configured to simultaneously execute, during a first sequential subset of the first time period, the instructions within the decompressed first sequential command file associated with the identifier for the respective lighting unit.

According to an embodiment, the system further includes a controller device comprising a communications module in communication with the gateway, and configured to transmit the instructions for the dynamic lighting pattern to the gateway.

According to an embodiment, the system is configured such that a transmitted sequential command file experiences no more than two hops during transmission from the gateway to a lighting unit.

According to an embodiment, the controller is further configured to generate a plurality of transmission packets, wherein a full length of each transmission packet is utilized.

According to an embodiment, each of the plurality of lighting units is configured to determine whether a complete sequential command file is received.

According to an embodiment, each of the plurality of lighting units is configured to receive a subsequent sequential command file while executing a previous sequential command file.

According to an embodiment, the controller is further configured to adjust one of more of the sequential command files based on a capacity of the system and/or a modification of the lighting system.

According to an aspect, a method for dynamic lighting within a lighting network is provided. The lighting network includes a plurality of lighting units each comprising an identifier and being in narrow bandwidth wireless communication with a gateway. The identifier for each lighting unit could be obtained through commissioning. The method includes the steps of: (i) receiving instructions for a dynamic lighting pattern for a first time period for the plurality of lighting units; (ii) generating a plurality of sequential command files each comprising information for a sequential subset of the first time period, each of the plurality of sequential command files further comprising instructions for timing and color for each of the plurality of lighting units, each of said instructions associated with an identifier for a respective lighting unit; (iii) compressing each of the plurality of sequential command files; (iv) transmitting, by the gateway via the narrow bandwidth wireless communication, a first one of the plurality of sequential command files to the plurality of lighting units, wherein each of the plurality of lighting units are configured to receive and decompress the first sequential command file, and further configured to simultaneously execute, during a first sequential subset of the first time period, the instructions within the decompressed first sequential command file associated with the identifier for the respective lighting unit; and (v) transmitting, by the gateway via the narrow bandwidth wireless communication, a second one of the plurality of sequential command files to the plurality of lighting units, wherein each of the plurality of lighting units are configured to receive and decompress the second sequential command file, and further configured to simultaneously execute, during a second sequential subset of the first time period, the instructions within the decompressed second sequential command file associated with the identifier for the respective lighting unit.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radio luminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a lighting system comprising a plurality of lighting units, in accordance with an embodiment.

FIG. 2 is a schematic representation of a lighting system comprising a plurality of lighting units, in accordance with an embodiment.

FIG. 3 is a flowchart of a method for dynamic lighting within a lighting network, in accordance with an embodiment.

### DETAILED DESCRIPTION OF EMBODIMENTS

The present disclosure describes various embodiments of a lighting system configured to execute a dynamic lighting pattern. More generally, Applicant has recognized and appreciated that it would be beneficial to provide for the communication of lighting pattern information to a plurality of coordinated lighting units in a lighting network. A particular goal of utilization of certain embodiments of the present disclosure is to execute a dynamic lighting pattern using a low-bandwidth wireless communication network.

In view of the foregoing, various embodiments and implementations are directed to a lighting system including a plurality of lighting units, each with a unique identifier, in wireless communication with a gateway via a low bandwidth communication method. The system receives instructions for a dynamic lighting pattern, and generates sequential command files for a subset of the lighting pattern time period, each of the command files including instructions for timing and a color or color pattern for each of the plurality of lighting units. A single sequential command file contains instructions for all of the lighting units, and instructions for each lighting unitare associated with the unique identifier for that lighting unit. The lighting unitreceives the compressed instructions, decompresses them, and adds them to a buffer to be executed. Subsequent command files are then sent by the system and received by the lighting units for execution.

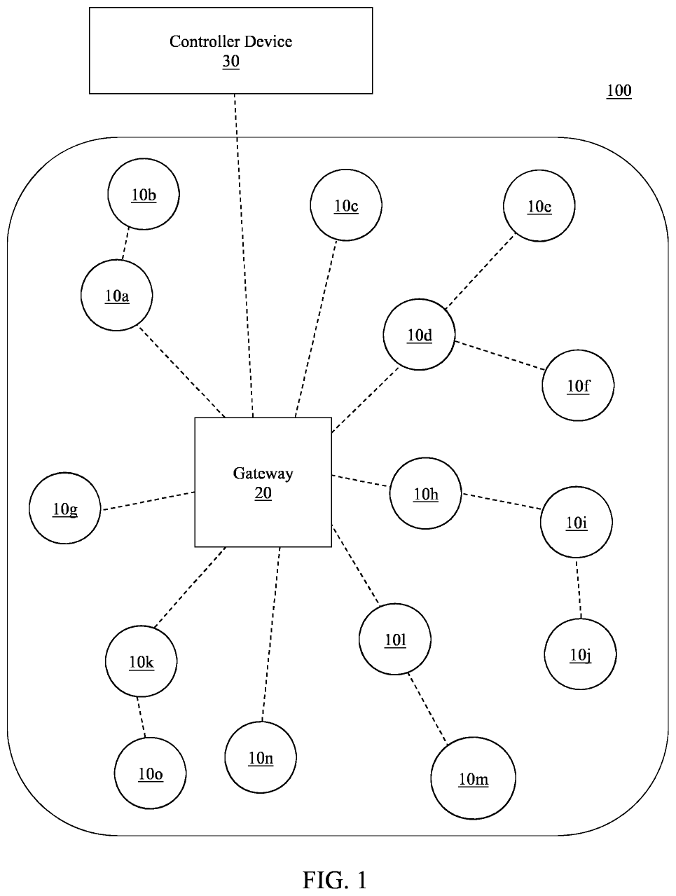

Referring to FIG. 1, in one embodiment, is a lighting system 100 comprising a plurality of lighting units 10a through 10o, a gateway 20, and a controller device 30. The lighting system can be any lighting system or network configured or designed for dynamic lighting. For example, the lighting system can be any exterior or interior lighting system. According to an embodiment, the lighting system 100 is implemented in a retail store, shopping mall, museum, exhibition show, building display, bridge display, or any other interior or exterior lighting network.

According to an embodiment, lighting units 10 within lighting system 100 are in wireless communication with a gateway 20, which can be any device configured for wireless communication. For example, gateway 20 may be a hub, server, computer, or other device. The wireless communication is a low-bandwidth wireless communication system such as ZigBee® or Bluetooth®, among many other possible low-bandwidth wireless communication methods. According to an embodiment, lighting units 10 within lighting system 100 are also in wireless communication with each other via the same or a different low-bandwidth wireless communication system.

According to an embodiment, gateway 20 is in wired and/or wireless communication with a controller device 30. Controller device 30 may be any handheld computing device, laptop, desktop, server, or other device configured to communicate dynamic lighting information to gateway 20. Controller device 30 may be located together with the lighting units 10 and gateway 20, or may be located remote from these components. For example, controller device 30 may be a remote server or computer that communicates with gateway 20 via a network such as an intranet, the internet, or any other wired and/or wireless communication method.

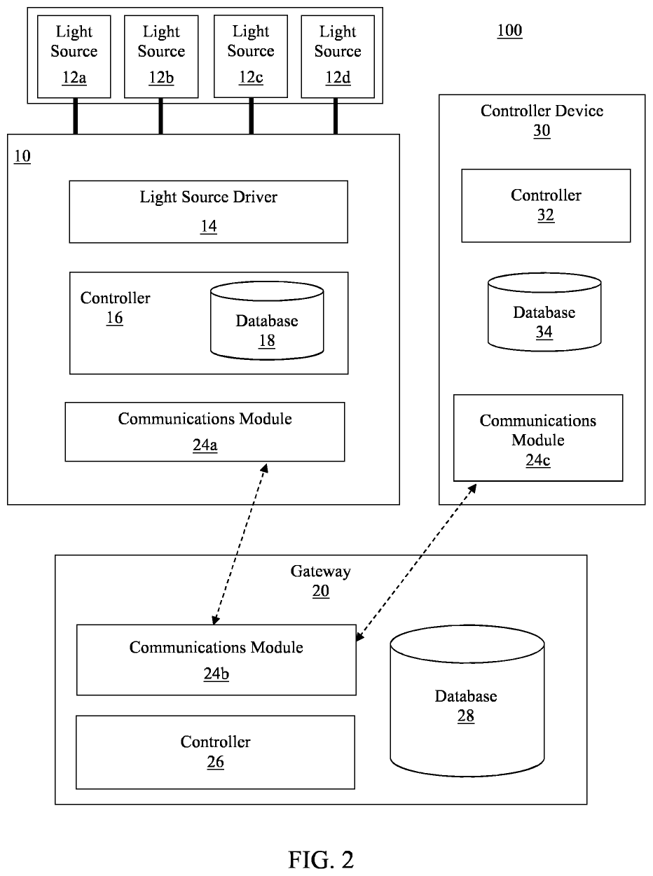

Referring to FIG. 2, in one embodiment, is a lighting system 100 comprising one of the plurality of lighting units 10, a gateway 20, and a controller device 30. According to an embodiment, lighting unit 10 is configured to emit light. For example, the lighting unit includes one or more light sources 12, where one or more of the light sources may be an LED-based light source. Further, the LED-based light source may have one or more LEDs. The light source can be driven to emit light of predetermined character (i.e., color intensity, color temperature) by one or more light source drivers 14. Many different numbers and various types of light sources (all LED-based light sources, LED-based and non-LED-based light sources alone or in combination, etc.) adapted to generate radiation of a variety of different colors may be employed in the lighting unit 10. According to an embodiment, lighting unit 10 can be any type of lighting fixture, including but not limited to any interior or exterior lighting fixture. One or more of the lighting units may be unique compared to the others within the system. According to one embodiment, each of the lighting units may be unique. The lighting units may be different sizes or shapes, may have different lighting angles, different outputs, different intensities, different colors, and/or different heights, among many other types of customizations.

According to an embodiment, lighting unit 10 includes a controller 16 that is configured or programmed to output one or more signals to drive the one or more light sources 12a-d and generate varying intensities, directions, and/or colors of light from the light sources. Controller 16 may take any suitable form, including but not limited to a microcontroller, multiple microcontrollers, circuitry, a single processor, or plural processors. Controller 16 may comprise a database 18 which can take any suitable form, including a non-volatile memory and/or RAM. The non-volatile memory may include read only memory (ROM), a hard disk drive (HDD), or a solid state drive (SSD). The memory can store, among other things, an operating system. The RAM is used by the processor for the temporary storage of data. According to an embodiment, an operating system may contain code which, when executed by the controller, controls operation of one or more components of the lighting unit.

Lighting unit 10 also includes a communications module 24a configured for wireless communication via the low-bandwidth wireless communication method with gateway 20. The communications module may also be configured for wireless communication with other lighting units 10 within the lighting network 100.

Lighting system 100 also comprises a gateway 20 configured to communicate with the lighting units 10 and the controller device 30. Gateway 20 comprises a controller 26 configured or programmed to control or execute operation of one or more components of the gateway, and to execute one or more steps of the methods described or otherwise envisioned herein. Controller 26 may take any suitable form, including but not limited to a microcontroller, multiple microcontrollers, circuitry, a single processor, or plural processors.

Gateway 20 comprises a database 28 which can take any suitable form, including a non-volatile memory and/or RAM. Database 28 is configured to store all or a portion of a dynamic lighting pattern, as well as unique identifiers for the plurality of lighting units 10. The database may also store an operating system comprising code which, when executed by the controller, controls operation of one or more components of the gateway.

Gateway 20 also comprises a communications module 24b configured for wireless communication via the low-bandwidth wireless communication method with one or more of the lighting units 10. Communications module 24b is also configured for wired and/or wireless communication with controller device 30.

Lighting system 100 also comprises a controller device 30 configured to communicate with the gateway 20. Controller device 30 may be any computing device such as a handheld computing device, laptop, desktop, server, or other device configured to communicate dynamic lighting information to gateway 20. Controller device 30 comprises a communications module 24c configured for wired and/or wireless communication with gateway 20.

Controller device 30 also comprises a controller 32 configured or programmed to control or execute operation of one or more components of the controller device, and to execute one or more steps of the methods described or otherwise envisioned herein. Controller 32 may take any suitable form, including but not limited to a microcontroller, multiple microcontrollers, circuitry, a single processor, or plural processors.

Controller device 30 comprises a database 34 which can take any suitable form, including a non-volatile memory and/or RAM. Database 34 is configured to store all or a portion of a dynamic lighting pattern, as well as unique identifiers for the plurality of lighting units 10. The database may also store an operating system comprising code which, when executed by the controller, controls operation of one or more components of the controller device 30.

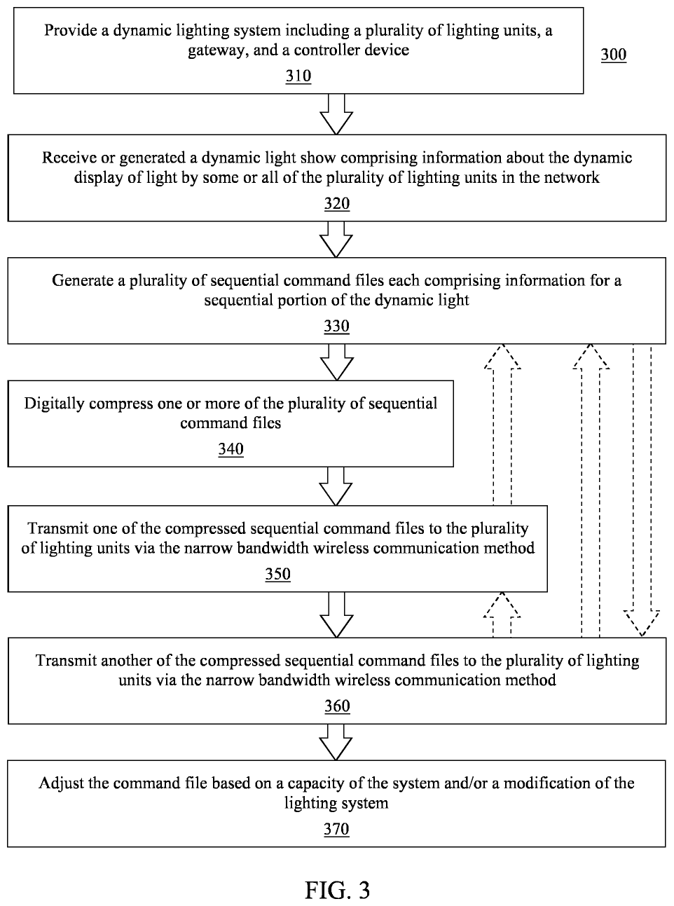

Referring to FIG. 3, in one embodiment, is a flowchart illustrating a method 300 for dynamic lighting within a lighting network. According to an embodiment, the method is configured to work with a lighting system 100 comprising a plurality of lighting units 10 and a gateway 20. Lighting system 100 can be any of the embodiments described herein or otherwise envisioned, including but not limited to the lighting systems described in conjunction with FIGS. 1 and 2. According to an embodiment, each lighting unit 10 is configured to illuminate all or a portion of a target surface within the lighting environment. Accordingly, at step 310 of the method, a lighting system 100 is provided comprising a plurality of lighting units 10, a gateway 20, and a controller device 30.

According to an embodiment, providing a lighting system 100 further comprises providing or generating commissioning information for the plurality of lighting units within the system. For example, the system may comprise information about the lighting units such as location, unique identifier, and other information.

At step 320 of the method, all or a portion of a dynamic light show is generated or received, comprising information about the dynamic display of light by some or all of the plurality of lighting units in the network. According to an embodiment, the dynamic light show information is generated by the controller device 30. For example, controller device 30 may be or comprise software configured or designed to generate or otherwise create dynamic light shows. Accordingly, controller device 30 may comprise information about the location and unique identifiers of the lighting units in the system, and may utilize that information to generate the dynamic light show. For example, controller device 30 may be a smartphone comprising a software application enabling the creation of a dynamic light show. According to another embodiment, the controller device 30 receives the dynamic light show information from another device via a wired and/or wireless communication network.

At step 330 of the method, controller device 30 and/or gateway 20 generates a plurality of sequential command files each comprising information for a sequential portion of the dynamic light show time period. The command files also include instructions for timing and color for each of the plurality of lighting units, with each command for each lighting unit associated with the unique identifier for that lighting unit. For example, the sequential command files may comprise lighting instructions for some or all of the plurality of lighting units for a certain time and/or frame rate, such as 1 second with 30 frames per second (fps).

At step 340 of the method, the system compresses one or more of the plurality of sequential command files. Any compression algorithm may be utilized to compress a command file. For example, comparable voice compression algorithms enable a compression rate of 10:1. Thus, a 10 KB file is 1 KB after compression. If the compression rate is 5:1, a 24 KB file will be 4.8 KB (38.4 Kbps), and if the compression is 10:1, a 24 KB file will be 19.2 Kbps.

The file comprises all of the information necessary for all of the lighting units to execute the dynamic lighting for a predetermined time period, such as one second of the dynamic lighting show or pattern. For example, if there are 200 lighting units in the system and each lighting unit requires 3 bytes for a show rate of 40 frames per second, the data file would require a bandwidth of 24 KB or 19.2 Kps (200*3*40). If 80 valid bytes can be transmitted for one packet, only 30 packets are needed to transmit a 24 KB file for 200 lighting units working with 40 frames per second. Therefore, according to an embodiment, controller device 30 and/or gateway 20 splits a command file into a transmission packet comprising up to 127 bytes, and then transmits one or more of the packets out with a duration of, for example, 15 or 20 ms.

According to an embodiment, the full length of the transmission packets communicating the command file is utilized. For example, for a transmission packet having a length capacity of 127 bytes, the full 127 bytes will be utilized. This maximizes system capacity, which is especially important for low-bandwidth communication methods.

At step 350 of the method, the gateway 20 transmits a first one of the plurality of sequential command files to the plurality of lighting units via the narrow bandwidth wireless communication method. According to an embodiment, rather than sending individual commands to each lighting unit individually, a single file is sent for a single time period, such as one second. The file comprises all of the information necessary for all of the lighting units to execute the dynamic lighting for that time period.

According to an embodiment, each of the plurality of lighting units are configured to receive and decompress the first sequential command file, and further configured to simultaneously execute, during a first sequential subset of the first time period, the instructions within the decompressed first sequential command file associated with the identifier for the respective lighting unit. Since the gateway 20 transmits the first sequential command file in a series of packets, the lighting unit will receive and assemble the packets into a complete compressed file. The lighting unit can then check, for example, to determine whether a complete compressed file was received. If a full file is received, the lighting unit can then decompress the received compressed data file and obtain the information, such as RGB colors, needed to execute its portion of the dynamic lighting pattern. For example if the file comprises a 1 second time period with 40 frames per second, the file may comprise information of up to 40 colors. The lighting unit may then implement fading of 25 ms for each color, according to an embodiment.

According to an embodiment, each of the plurality of lighting units is configured to receive a subsequent sequential command file while executing a previous sequential command file. For example, while a lighting unit is executing the first command file for the first one second duration, the lighting unit can receive, analyse/deconstruct, and buffer a subsequent command file to be executed during the second one second duration. The lighting unit may temporarily store a re-assembled and decompressed command file in memory until it is ready for execution.

According to an embodiment, the first sequential command file comprises a time stamp and/or duration configured to provide information to a lighting unit regarding a time to start execution of the lighting pattern, as well as timing and duration of the lighting pattern. According to an embodiment, a synchronization signal could be used to synchronize the start time.

According to an embodiment, lighting system 100 is configured such that a transmitted sequential command file experiences no more than two hops during transmission from the gateway 20 to the lighting unit 10 where it the file is decompressed and executed. For example, if one hop comprises a delay of 30 ms, two hops have a delay of 60 ms. If the goal is to limit latency to less than 100 ms at which transitions will appear fluid to human eyes, hops of 30 ms or more must be limited to a total of two. There are multiple ways to limit hops to two or fewer. For example, one method to limit hops is to ensure that the transmission power of gateway 20 is sufficient such that each of the lighting units is no greater than two hops from the reach of the gateway. Another method to limit hops is to ensure that the gateway is positioned relative to the lighting units such that the lighting units receive a transmission from the gateway either directly or via one or two hops.

At step 360 of the method, gateway 20 transmits a second one of the plurality of sequential command files to the plurality of lighting units via the narrow bandwidth wireless communication method. The file comprises all of the information necessary for all of the lighting units to execute the dynamic lighting for the second time period, such as the next second of the lighting pattern. According to an embodiment, each of the plurality of lighting units are configured to receive and decompress the second sequential command file, and further configured to simultaneously execute, during the second time period, the instructions within the decompressed sequential command file associated with the identifier for the respective lighting unit.

At optional step 370 of the method, the system adjusts the command file based on a capacity of the system and/or a modification of the lighting system. For example, the system may detect that one or more of the lighting units has moved, that there are more or fewer lighting units, that the system is over-capacity, that the gateway has moved, and/or one or more other changes or situations. Accordingly, to ensure a seamless dynamic lighting pattern, the system adjusts one or more of the command files.

According to an embodiment, the system can implement an adaptive frame rate based in whole or in part on channel condition and the number of lighting units. The frame rate may be adjusted based on the wireless channel condition. For example, if the channel quality is not suitable, the frame rate can be reduced to a lower rate, such as 20 frames/second among other possible rates.

According to an embodiment, rather than an adaptive frame rate the system can implement Forward Error Correction (FEC), a system or method typically utilized to correct bit errors at the physical-layer. However, FEC can be adapted to operate on packets at the network layer to improve application performance across WANs that have high-loss characteristics. According to an embodiment, packet-level FEC adds an additional loss recovery packet for every “N” packets that are sent, which enables lighting units to reconstitute lost packets, thereby avoiding transport-layer retransmissions. For example, introducing one loss recovery packet for every 10 regular packets (1:10 FEC) can reduce a 1% packet loss to less than 0.09%. Introducing one loss recovery packet for every packets (1:5 FEC) can reduce that same 1% packet loss to less than 0.04%. In the extreme, 1:5 FEC can even reduce a 5% loss to less than 1%. In real deployments, FEC can be adaptive to accommodate different loss conditions.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

1. A system for dynamic lighting, the system comprising:
a plurality of lighting units, each comprising at least one light source, a unique identifier, and a communications module; and
a gateway (20) comprising a communications module configured to communicate via a low-bandwidth wireless communication method with the communications module of the lighting units, and comprising a controller configured to: (i) receive instructions for a dynamic lighting pattern for a first time period for the plurality of lighting units; (ii) generate a plurality of sequential command files each comprising information for a sequential subset of the first time period, each of the plurality of sequential command files further comprising instructions for timing and color for each of the plurality of lighting units, each of said instructions associated with an identifier for a respective lighting unit; (iii) compress each of the plurality of sequential command files; and (iv) transmit a first one of the plurality of sequential command files to the plurality of lighting units;
wherein each of the plurality of lighting units are configured to receive and decompress the first sequential command file, and further configured to simultaneously execute, during a first sequential subset of the first time period, the instructions within the decompressed first sequential command file associated with the identifier for the respective lighting unit, and
wherein the controller is further configured to adjust one of more of the sequential command files based on a modification of the lighting system.

2. The system of claim 1, further comprising a controller device comprising a communications module in communication with the gateway, and configured to transmit the instructions for the dynamic lighting pattern to the gateway.

3. The system of claim 1, wherein the system is configured such that a transmitted sequential command file experiences no more than two hops during transmission from the gateway to a lighting unit.

4. The system of claim 1, wherein the controller is further configured to generate a plurality of transmission packets, wherein a full length of each transmission packet is utilized.

5. The system of claim 1, wherein each of the plurality of lighting units is configured to determine whether a complete sequential command file is received.

6. The system of claim 1, wherein each of the plurality of lighting units is configured to receive a subsequent sequential command file while executing a previous sequential command file.

7. (canceled)

8. A method for dynamic lighting within a lighting network comprising a plurality of lighting units, each of the plurality of lighting units comprising an identifier and being in narrow bandwidth wireless communication with a gateway, comprising the steps of:
receiving instructions for a dynamic lighting pattern for a first time period for the plurality of lighting units;
generating a plurality of sequential command files each comprising information for a sequential subset of the first time period, each of the plurality of sequential command files further comprising instructions for timing and color for each of the plurality of lighting units, each of said instructions associated with an identifier for a respective lighting unit;
adjusting one of more of the sequential command files based on a modification of the lighting system;
compressing each of the plurality of sequential command files;
transmitting, by the gateway via the narrow bandwidth wireless communication, a first one of the plurality of sequential command files to the plurality of lighting units, wherein each of the plurality of lighting units are configured to receive and decompress the first sequential command file, and further configured to simultaneously execute, during a first sequential subset of the first time period, the instructions within the decompressed first sequential command file associated with the identifier for the respective lighting unit; and
transmitting, by the gateway via the narrow bandwidth wireless communication, a second one of the plurality of sequential command files to the plurality of lighting units, wherein each of the plurality of lighting units are configured to receive and decompress the second sequential command file, and further configured to simultaneously execute, during a second sequential subset of the first time period, the instructions within the decompressed second sequential command file associated with the identifier for the respective lighting unit.

9. The method of claim 8, wherein the lighting network is configured such that a transmitted sequential command file experiences no more than two hops during transmission from the gateway to a lighting unit.

10. The method of claim 8, further comprising the step of generating, by the gateway, a plurality of transmission packets, wherein a full length of each transmission packet is utilized.

11. The method of claim 8, wherein each of the plurality of lighting units is configured to determine whether a complete sequential command file is received.

12. The method of claim 8, wherein each of the plurality of lighting units is configured to receive a subsequent sequential command file while executing a previous sequential command file.

13. (canceled)

14. The method of claim 13, wherein the step of adjusting one of more of the sequential command files comprises adjusting a frame rate of the command file.

15. The method of claim 13, wherein the step of adjusting one of more of the sequential command files comprises implementing forward error correction.
